(19) United States
(12) Patent Application Publication
(10) Pub. No.: US 2010/0084822 A1
(43) Pub. Date: Apr. 8, 2010

(54) Two-Part Piston Rod Gasket

(76) Inventor: Andreas GIMSA, Michendorf (DE)

Correspondence Address: FAY KAPLUN & MARCIN, LLP, 150 BROADWAY, SUITE 702, NEW YORK, NY, 10038, US

(21) Appl. No.: 12/573,444

(22) Filed: Oct. 5, 2009

(30) Foreign Application Priority Data
Oct. 8, 2008 (DE) 10 2008 050 426.2

(51) Int. Cl. F16J 15/16

(52) U.S. Cl. 277/545

(57) ABSTRACT

A divided piston rod gasket for use in Stirling motors and compressors comprises two segments, adjusts by sliding and achieves a long service life.

### PRIORITY CLAIM

The present application claims priority to DE Patent Application Serial No. DE 10 2008 050 426.2 filed Oct. 8, 2008. The disclosure of the above-identified application is incorporated herewith by a reference.

### BACKGROUND INFORMATION

Divided piston rod gaskets are adequately known in the most varied of embodiments. The joints can be configured variously. Thus, there are for example straight, inclined, overlapping and gas-tight joints. Also two-part piston rod gaskets are known. However these have only a small adjustment clearance when worn. The service life is low and leaks occur. This proves to be particularly problematic if only non-elastic materials are possible as gasket materials as a result of high operating temperatures.

### SUMMARY OF INVENTION

The present invention relates to a two-part piston rod gasket. The gasket includes 2 segments which are formed by division cuts which extend parallel to each other, respectively tangentially beginning at the inner diameter towards the outer diameter. The spacing of the parallel lines corresponding to the inner diameter. The present invention using geometry for a piston rod gasket which can be manufactured both from plastic material and graphite.

### BRIEF DESCRIPTION OF DRAWINGS

FIG. 1 shows a gasket according to an exemplary embodiment of the present invention.

FIG. 2 shows another view of the gasket of FIG. 1 along line AA.

### DETAILED DESCRIPTION

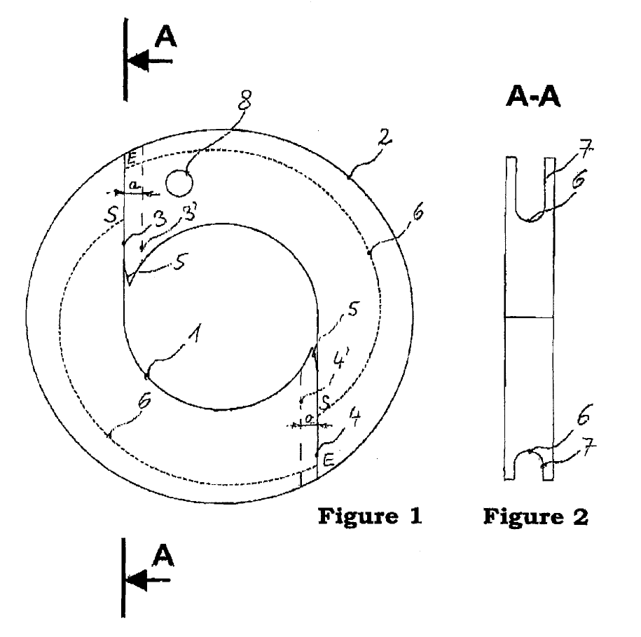

The two-part piston rod gasket as shown in FIGS. 1 and 2 and according to the present invention is characterised in that its 2 segments are formed by division cuts [3] and [4] which extend parallel to each other, respectively tangentially beginning at the inner diameter [1] towards the outer diameter [2], the spacing of the parallel lines corresponding to the inner diameter [1]. The possibility exists as an alternative segment formation that the division cuts begin not directly tangentially at the inner diameter [1] but extend at a defined spacing [a] relative to the tangents [3] and [4] as cuts [3′] and [4′].

In order to adjust a ring prestressing, an external groove [7] with the groove base [6] can be incorporated over the circumference of the ring in order to receive a spiral spring. The groove has its optimal geometry when the spring pretension is also maintained if the ring is already somewhat worn. For this purpose, the groove [7] is provided with a spiral configuration with a starting point [S] at which the groove base [6] is situated lower than at the end point [E] in order that a spiral spring which is stretched around the circumference of the piston rod gasket can exert, even after wear develops, a permanent pressure for pressing together both ring segments.

In order that both segments of the piston rod gasket are provided with a large clearance for the wear-related parallel compression together, a recess [5] can be configured respectively at one end of both segments.

A favourable geometry for the recess [5] is the form of a sector of a circle in order that the segment ends slide into the inner diameter in a form fit when the segments are pressed together.

At least one segment of the piston rod gasket can be provided with a non-continuous boring [8] for a securing element in order to ensure that, when using 2 completely identical gaskets which are disposed one above the other, their borings come to be aligned orientated towards each other and hence the recesses [5] of the segments are not situated one above the other in order to avoid leaks. With this or a further boring, distortion-resistance of the gasket can also be achieved.

Advantageous materials of use for the ring segments of the 2-part piston rod gasket are isostatically pressed graphite, Teflon, boron nitride or similar materials.

Some of advantages of the piston rod gasket according to the present invention include the good gas seal, lack of friction, long service life as a result of long adjustment paths and also a simple geometry.

### REFERENCE NUMBER LIST

1 Inner diameter of the piston rod gasket
2 Outer diameter of the piston rod gasket
3 First tangential division cut
4 Second tangential division cut
3′ Alternative first division cut
4′ Alternative second division cut
5 Recess at the segment end
6 Groove base of the circumferential groove [7]
7 Groove of the piston rod gasket for receiving e.g. a spiral spring
8 Boring for receiving a securing element
a Spacing of the tangential and the alternative cut line
S Starting point of the groove base [6]
E End point of the groove base [6]

1. A two-part piston rod gasket, comprising:
first and second segments formed by division cuts which extend parallel to each other, respectively tangentially beginning at an inner diameter towards an outer diameter, wherein spacing of parallel lines corresponds to the inner diameter.

2. The gasket according to claim 1, wherein the division cuts begin not directly tangentially at the inner diameter, but extend at a defined spacing relative to tangents as alternative cuts.

3. The gasket according to claim 1, wherein an external groove with the groove base is incorporated over a circumference of a ring.

4. The gasket according to claim 3, wherein the groove is adapted to receive a spiral spring in order to adjust a ring prestressing.

5. The gasket according to claim 3, wherein the groove is provided with a spiral configuration with a starting point at which the groove base is situated lower than at an end point in order that a spiral spring which is stretched around the circumference of the gasket exerts a permanent pressure for pressing together both the first and second segments.

6. The gasket according to claim 1, wherein a recess is configured respectively at one end of the first and second segments in order that the first and second segments are provided with a large clearance for a wear-related parallel compression together.

7. The gasket according to claim 6, wherein the recess is provided with a form of a sector of a circle in order that the segment ends slide into the inner diameter in a form fit when the first and second segments are pressed together.

8. The gasket according to claim 7, wherein at least one of the first and second segments is provided with a non-continuous boring for a securing element in order to ensure that, when using two completely identical gaskets which are disposed one above the other, their borings come to be aligned orientated towards each other and hence the recesses of the first and second segments are not situated one above the other in order to avoid leaks.

9. The gasket according to claim 1, wherein each of the first and second segments comprise of one of isostatically pressed graphite material, Teflon material and boron nitride material.
